(19) United States
(12) Patent Application Publication
(10) Pub. No.: US 2016/0237951 A1
(43) Pub. Date: Aug. 18, 2016

(54) DEVICE AND A METHOD FOR FEEDING A ROCKET ENGINE PROPULSION CHAMBER

(71) Applicant: SNECMA, Paris (FR)

(72) Inventors: Jean Michel SANNINO, Saint-Marcel (FR); Emmanuel EDELINE, Ecos (FR); David HAYOUN, Paris (FR)

(73) Assignee: SNECMA, Paris (FR)

(21) Appl. No.: 15/141,431

(22) Filed: Apr. 28, 2016

Related U.S. Application Data
(63) Continuation-in-part of application No. 13/904,584, filed on May 29, 2013.

(30) Foreign Application Priority Data
May 30, 2012 (FR) 12 54965

(51) Int. Cl. F02K 9/46; F02K 9/60

(52) U.S. Cl. CPC F02K 9/46; F02K 9/605

(57) ABSTRACT

The invention relates to a device and a method for feeding a propulsion chamber of a rocket engine with at least with a first propellant. The device comprises at least a first tank for containing the first propellant, a first feed circuit connected to the first tank, and a first electric pump within the first tank in order to pump the first propellant through the first feed circuit. In the method, the first propellant is pumped through the first feed circuit from the first tank by at least the first electric pump that is immersed in the first propellant within the first tank.

### CROSS-REFERENCE TO RELATED APPLICATIONS

The present application is a continuation-in-part application of U.S. patent application Ser. No. 13/904,584, filed on May 29, 2013, and is based on and claims priority pursuant to 35 U.S.C. §119 from French Patent Application No. 12 54965, filed on May 30, 2012. The entire contents of each of the above applications are hereby incorporated herein by reference in entirety.

### BACKGROUND OF THE INVENTION

The present invention relates to the field of feeding reaction engines and in particular it relates to a device and a method for feeding a propulsion chamber at least with a first propellant.

In the description below, the terms “upstream” and “downstream” are defined relative to the normal flow direction of a propellant in a feed circuit.

In reaction engines, and in particular in rocket engines, thrust is typically generated by hot combustion gas that is produced by an exothermal chemical reaction that has taken place within a propulsion chamber and that expands in a propulsion chamber nozzle. Consequently, high pressures normally exist in the propulsion chamber while it is in operation. In order to be able to continue to feed the combustion chamber in spite of those high pressures, propellants need to be introduced at pressures that are even higher. Various means are known in the prior art for achieving this.

First means that have been proposed comprise pressurizing the tank containing the propellants. Nevertheless, that approach greatly restricts the maximum pressure that can be reached in the propulsion chamber and thus restricts the specific impulse of the reaction engine. Consequently, in order to reach higher specific impulses, the use of feed pumps has become common practice. Various means have been proposed for actuating such pumps, and most frequently they are driven by at least one turbine. In such a turbopump, the turbine itself may be actuated in various different ways. For example, the turbine may be actuated by combustion gas produced by a gas generator. Nevertheless, in so-called “expander cycle” rocket engines, the turbine is actuated by one of the propellants after it has passed through a heat exchanger in which it is heated by the heat produced in the propulsion chamber. Thus, this transfer of heat can contribute simultaneously to cooling the walls of the propulsion chamber while also actuating at least one feed pump.

Under certain circumstances, it may be desirable to be able to select between a plurality of stable levels of thrust. In particular, it is now desired for the rocket engines of the final stages of satellite launchers to have not only a function of putting the payload into orbit, but also a function of de-orbiting the final stage. In order to perform such de-orbiting, and in particular in order to ensure that the final stage falls at an accurate point, it is preferable to make use of a level of thrust that is substantially smaller than the level of thrust used while putting the payload into orbit. Nevertheless, both with pressurized tanks and with turbopumps it can be difficult to vary the flow rate of the propellants delivered to the propulsion chamber, and it can thus be difficult to vary the thrust that it produces. Furthermore, without prior boosting, the performance of turbopumps is limited by cavitation phenomena, in particular towards the end of emptying the tanks, and this normally prevents all of the propellant that is initially contained in each tank from being used up.

### OBJECT AND SUMMARY OF THE INVENTION

The present invention seeks to remedy those drawbacks. The invention seeks in particular to provide a feed device for feeding a rocket engine propulsion chamber with at least a first propellant, the device comprising at least a first tank for containing said first propellant and a first feed circuit connected to the first tank and enabling the propulsion chamber to be fed with propellant at a variable rate, while avoiding cavitation phenomena.

In at least one embodiment, this object is achieved by the fact that said feed device further comprises at least one first electric pump within said first tank for pumping said first propellant through the first feed circuit.

By means of these provisions, the flow rate of the first propellant feeding the propulsion chamber via the first feed circuit can be controlled by controlling the first electric pump. In addition, incorporating the first electric pump in the first tank makes it possible to limit the overall size of the assembly.

In a second aspect, said first feed circuit may further include a first inlet valve downstream from the first electric pump, which valve may in particular be incorporated within said first tank. While limiting the overall size of the assembly, the first inlet valve acting in combination with the first electric pump enables the flow rate of the first propellant feeding the propulsion chamber via the first circuit to be controlled accurately, and makes it possible to do to in simplified manner, and in particular without requiring additional flow rate-adjusting or outlet valves leading to the propulsion chamber downstream from the first valve.

In a third aspect, said first circuit may also further comprise a turbine. The first feed circuit may in particular be of the so-called “expander” cycle type, wherein said first feed circuit further comprises a heat exchanger configured to heat the first propellant with heat generated within the propulsion chamber, and the turbine is located downstream of the heat exchanger in the first feed circuit in order to actuate this turbine by expansion of the first propellant after it has been heated. However, the first feed circuit may alternatively be of the so-called “gas generator” type comprising a gas generator connected to the turbine in order to actuate this turbine by expansion of gas generated by the gas generator. The outlet of the turbine may be connected to the propulsion chamber or to an exhaust nozzle.

In a fourth aspect, the feed device may further include an electricity generator coupled to the turbine and connected to at least the first electric pump in order to power it electrically. It is thus possible in reliable manner to generate a considerable amount of electrical power for powering the first electric pump, with relatively little additional consumption of propellants and with additional mass and size that are also small.

In a fifth aspect, the feed device may further comprise, downstream from at least the first electric pump, at least one pump mechanically coupled to the turbine for pumping said first propellant through the first feed circuit. Thus, the first electric pump can serve to boost the turbopump, thus avoiding cavitation phenomena, while also controlling the flow rate of the first propellant.

In particular, it may be possible to incorporate the electricity generator within the turbopump without lengthening it, because of the spacing that is typically present between the pump and the turbine. Nevertheless, the power supply device may also comprise, either as an alternative or else in addition to such an electricity generator, at least one fuel cell connected to at least the first electric pump in order to power it electrically. The fuel cell may in particular be fed with the same propellants as the propulsion chamber.

In order to feed the propulsion chamber with at least two propellants, the feed device may further comprise at least one second tank for containing a second propellant and a second feed circuit connected to the second tank. In a fifth aspect, the feed device may then also comprise a second electric pump within said second tank in order to pump said second propellant through the second feed circuit. Like the first feed circuit, the second feed circuit may also include an inlet valve downstream from the electric pump, i.e. downstream from the second electric pump. The second electric pump may also be connected to receive electrical power from the same electrical power source as the first electric pump, or it may be connected to a different source. The propellants may in particular be cryogenic propellants, e.g. such as liquid hydrogen and liquid oxygen. With these specific propellants, given the comparatively high density of liquid oxygen, the second electric pump may suffice for pumping the liquid oxygen through the second circuit without requiring a turbopump downstream therefrom, even if a turbopump is indeed used for pumping liquid hydrogen downstream from the first electric pump.

The present invention also provides a method of feeding a rocket engine propulsion chamber with at least a first propellant. In at least one implementation, said first propellant is pumped via a first feed circuit from a first tank by at least one first electric pump immersed in the first propellant within the first tank.

### BRIEF DESCRIPTION OF THE DRAWINGS

The invention can be well understood and its advantages appear better on reading the following detailed description of several embodiments given as non-limiting examples. The description refers to the accompanying drawings, in which:

FIG. 1 is a diagrammatic view of a rocket engine with a feed device in a first embodiment of the invention;

FIG. 2 is a diagrammatic view of a rocket engine with a feed device in a second embodiment of the invention;

FIG. 3 is a diagrammatic view of a rocket engine with a feed device in a third embodiment of the invention; and

FIGS. 4, 5, and 6 are diagrammatic views of a rocket engine with a feed device in a fourth, fifth, and sixth embodiment of the invention, respectively.

### DETAILED DESCRIPTION OF THE INVENTION

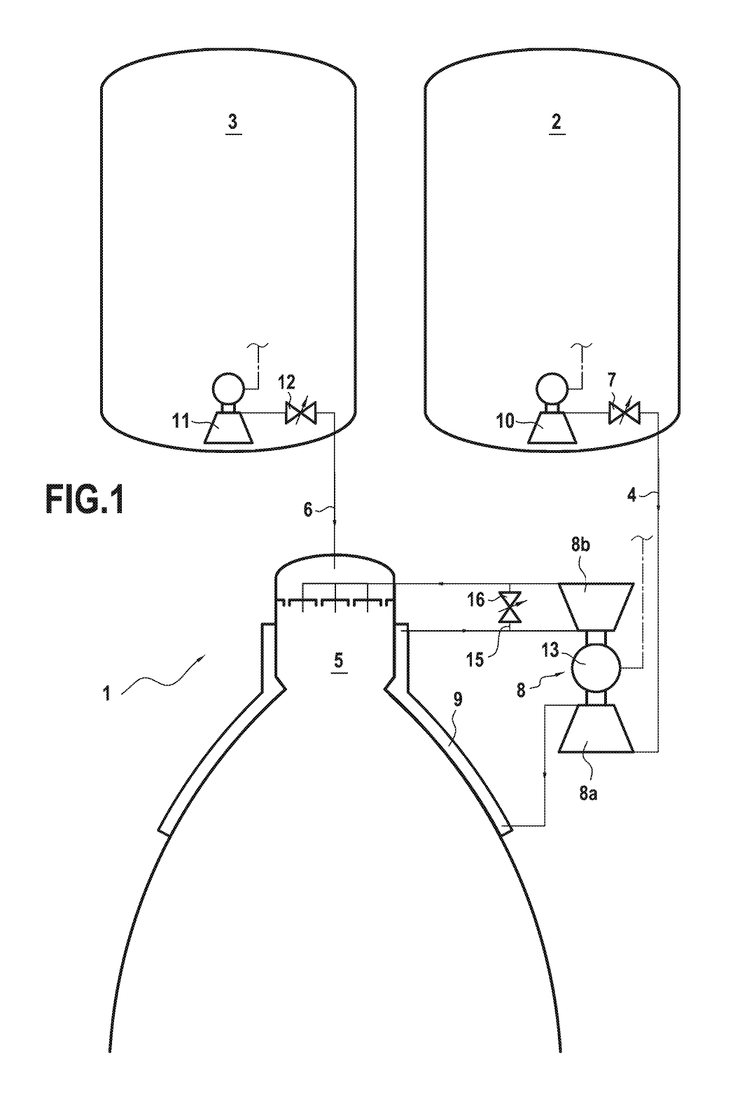

FIG. 1 shows a rocket engine 1 having a propulsion chamber 5 and a first embodiment of a feed device for feeding the propulsion chamber with hydrogen and oxygen. The feed device comprises a tank 2 containing hydrogen in the liquid state, a tank 3 containing oxygen in the liquid state, a feed circuit 4 connected to the tank 2 to deliver hydrogen to the propulsion chamber 5 of the rocket engine 1, and a feed circuit 6 connected to the tank 3 to deliver oxygen to the propulsion chamber 5.

In addition, in this first embodiment, the hydrogen circuit 4 has an inlet valve 7, a turbopump 8 with a pump 8a and a turbine 8b that are mechanically coupled together, and a heat exchanger 9 formed in the walls of the propulsion chamber 5 in such a manner as to transfer heat from the propulsion chamber 5 to the hydrogen while it flows through the heat exchanger 9. The heat exchanger 9 is situated in the first circuit 4 downstream from the pump 8a and upstream from the turbine 8b. Thus, heat transfer in the heat exchanger 9 contributes simultaneously to cooling the walls of the propulsion chamber 5 and to vaporizing the liquid hydrogen between the pump 8a and the turbine 8b. The expansion of the hydrogen in the gaseous state through the turbine 8b then actuates the turbopump 8. Thus, the hydrogen circuit 4 in this first embodiment operates in an “expander” cycle. This hydrogen circuit 4 also has a bypass passage 15 for bypassing the turbine 8b and including a bypass valve 16.

The feed device of the rocket engine 1 in FIG. 1 also includes an electric pump 10 immersed in the liquid hydrogen in the first tank 2 for the purpose of pumping hydrogen through the circuit 4 so as to boost the turbopump 8 and so as to prevent cavitation phenomena. The electric pump 10 and the inlet valve 7 may be incorporated in a single module within the liquid hydrogen tank 2 so as to simplify their assembly and so as to limit their bulk.

In the liquid oxygen tank 3, the feed device also has an electric pump 11 for pumping liquid oxygen through the circuit 6, which circuit 6 also includes an inlet valve 12 suitable for being incorporated in the same module as the electric pump 10 within the liquid oxygen tank 3. Unlike the circuit 4, the liquid oxygen circuit 6 does not have a turbopump, the second electric pump 11 being capable on its own of pumping liquid oxygen because the density of liquid oxygen is higher than that of liquid hydrogen.

In order to power both of the electric pumps 10 and 11 electrically, the feed device also includes an electricity generator 13 installed on the shaft of the turbopump 8 between the pump 8a and the turbine 8b. The electric pumps 10 and 11, the inlet valves 7 and 12, and also the bypass valve 16 are connected to the control unit (not shown) for controlling the rocket engine 1.

In order to start the rocket engine 1, the inlet valves 7 and 12 are opened, and the electric pumps 10 and 11 are started, being powered electrically from an external electricity source or by batteries (not shown), for example. Since the electric pumps 10 and 11 are already immersed in the propellants in the tanks, there is no need to perform a step of cooling these pumps 10 and 11. The turbopump 8 is cooled by the liquid hydrogen pumped through it by the electric pump 10. At least until a pressure threshold is reached, the background heat around the heat exchanger 9 may be sufficient to vaporize the liquid hydrogen flowing through it, which should facilitate its ignition upon arrival into the propulsion chamber 5. On starting, the bypass valve 16 is open so that the flow of liquid or gaseous hydrogen can bypass the turbine 8b. When a sufficient flow of both propellants is delivered to the propulsion chamber 5, the mixture of propellants in the propulsion chamber 5 is ignited by at least one ignitor (not shown). Once ignition has occurred, the heat produced by the combustion of the mixture in the propulsion chamber 5 contributes to heating and vaporizing the liquid hydrogen that flows through the heat exchanger 9. The bypass valve 16 can then be closed progressively as to redirect the flow of gaseous hydrogen downstream from the heat exchanger 9 towards the turbine 8b and cause the speed of the turbopump 8 to rise. With this increase in the speed of the turbopump 8, the generator 13 can begin to generate electrical power for powering the electric pumps 10 and 11.

Thereafter, the consumption of propellants by the rocket engine 1 progressively empties the tanks 2 and 3. The speed of the electric pumps 10 and 11 may be regulated throughout the operation of the rocket engine 1 in order to avoid cavitation phenomena, in particular towards the end of the tanks 2 and 3 being emptied completely. Simultaneously, the boosting of the turbopump 8 by the electric pump 10 enables at least some minimum pressure level to be maintained at the inlet to the pump 8a, thereby likewise avoiding cavitation phenomena in the pump 8a, even at the end of emptying the tank 2. Although the functioning of the rocket engine 1 has been described for a propellant feeding process wherein the pressure of the hydrogen remains below the critical point, each propellant may be pumped at pressures above its respective critical point. In this rocket engine 1, if the hydrogen is pumped at a pressure above its critical point, it will not be vaporized in the heat exchanger 9, but instead flow as a supercritical fluid through the turbine 8b and into the propulsion chamber 5.

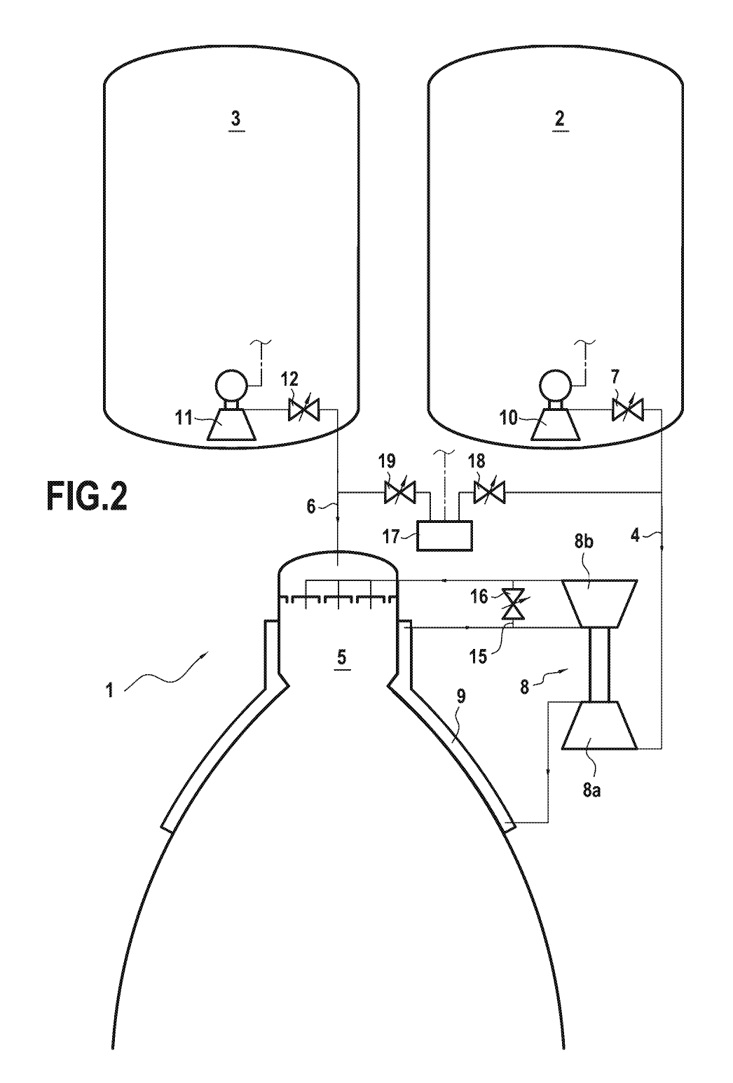

A rocket engine 1 with a feed device constituting a second embodiment is shown in FIG. 2. Most of the elements of this rocket engine 1 are identical or equivalent to those of FIG. 1 and consequently they are given the same reference numbers. The feed device in this second embodiment nevertheless differs from that of the first embodiment in that, instead of the generator 13, the device has a fuel cell 17 for electrically powering the electric pumps 10 and 11. This fuel cell 17 is connected to branch connections on the circuits 4 and 6 in order to be fed with hydrogen and oxygen. Valves 18 and 19 situated at the inlets of the fuel cell and also connected to a control unit (not shown) serve to control the operation of the fuel cell 17.

The operation of the feed device in this second embodiment is likewise analogous to the operation of the first embodiment, with the difference that once the electric pumps 10 and 11 have started, they are powered electrically by the fuel cell 17 instead of by a generator that is actuated by the turbopump 8.

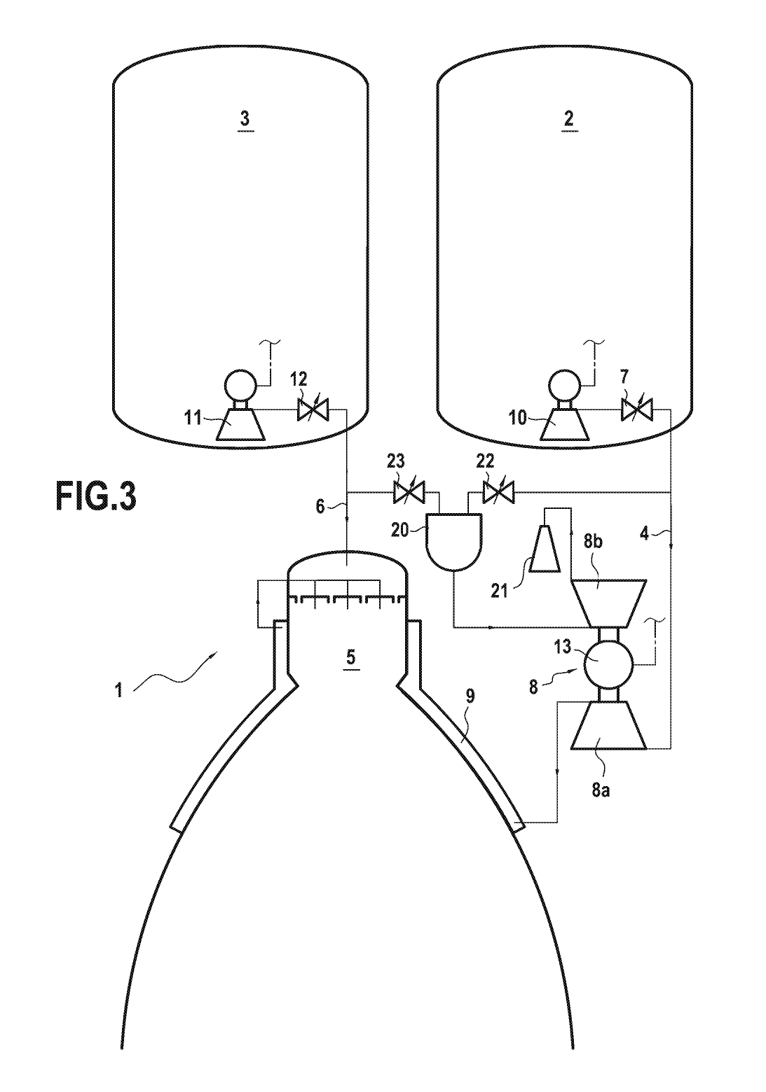

A rocket engine 1 with a feed device in a third embodiment is shown in FIG. 3. Many of the elements of this rocket engine 1 are identical or equivalent to those of FIG. 1, and consequently they are given the same reference numbers. The feed device in this third embodiment nevertheless differs from the first embodiment in that the hydrogen circuit 4 is not of the “expander” cycle type, but rather of the gas generator type. Thus, this feed device has a gas generator 20 connected to branch connections on the circuits 4 and 6 in order to be fed with hydrogen and oxygen, and has an exhaust circuit 21, with an exhaust nozzle, that passes through the turbine 8b in order to actuate the turbopump 8 by the expansion of the gas generated by the combustion of the propellants in this gas generator 20, instead of being actuated by the expansion of the gaseous hydrogen from the circuit 4 downstream from the heat exchanger. This also makes it possible to omit the passage bypassing the turbine. Valves 22 and 23 situated at the inlet to the gas generator 20 and also connected to the control unit (not shown) serve to control the operation of the gas generator 20.

The operation of the rocket engine 1 in FIG. 3 and of its feed device is similar to that of the first embodiment, except that the gas generator 20 may be ignited before the propulsion chamber 5 in order to advance starting of the turbopump 8, thereby avoiding at least in part the need for a source of electricity in addition to the electricity generator 13.

Although the embodiment shown in FIG. 3 has a circuit 4 of the open cycle type with the gas generated by the gas generator 20 being exhausted via a nozzle 21 separate from the propulsion chamber 5, it is possible in alternative embodiments for this circuit to use a closed cycle with the gas generated by the gas generator being injected into the propulsion chamber 5, and it is even possible for the circuit to be a staged-combustion circuit.

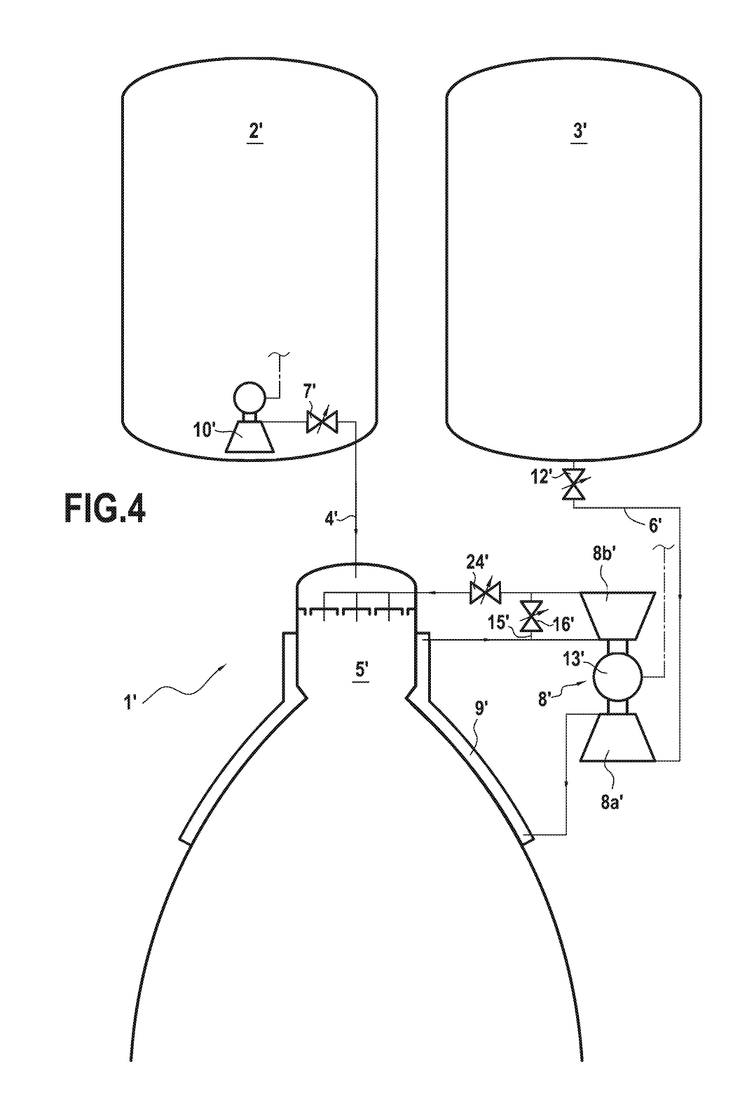

The rocket engine 1′ shown in FIG. 4 has a propulsion chamber 5′ and a feed device for feeding the propulsion chamber with hydrogen and oxygen in a fourth embodiment. This feed device comprises a tank 2′ containing oxygen in the liquid state, a tank 3′ containing hydrogen in the liquid state, a feed circuit 4′ connected to the tank 2′ in order to deliver oxygen to the propulsion chamber 5′ of the rocket engine 1′, and a feed circuit 6′ connected to the tank 3′ in order to deliver hydrogen to the propulsion chamber 5′.

Furthermore, in this fourth embodiment, the hydrogen circuit 6′ has an inlet valve 12′, a turbopump 8′ with a pump 8a′ and a turbine 8b′ that are mechanically coupled together, and a heat exchanger 9′ formed in the walls of the propulsion chamber 5′ so as to transfer heat from the propulsion chamber 5′ to the hydrogen while it is flowing through the heat exchanger 9′. The heat exchanger 9′ is situated in the circuit 6′ downstream from the pump 8a′ and upstream from the turbine 8b′. Thus, the transfer of heat in the heat exchanger 9′ contributes simultaneously to cooling the walls of the propulsion chamber 5′ and to vaporizing the liquid hydrogen between the pump 8a′ and the turbine 8b′. The expansion of the hydrogen in the gaseous state in the turbine 8b′ actuates the turbopump 8′. Thus, this circuit 6′ of the fourth embodiment operates with an “expander” cycle like the hydrogen circuit of the first embodiment. This circuit 6′ also includes a bypass passage 15′ bypassing the turbine 8b′ and including a bypass valve 16′, together with an outlet valve 24′ leading to the propulsion chamber 5′.

In the liquid oxygen tank 2′, the feed device has an electric pump 10′ for pumping liquid oxygen through the circuit 4′, which circuit also includes an inlet valve 7′ suitable for being incorporated in the same module as the electric pump 10′ within the liquid oxygen tank 3′. Unlike the circuit 6′, this liquid oxygen circuit 4′ does not include a turbopump, the electric pump 10′ being capable on its own of pumping liquid oxygen because of the higher density of liquid oxygen compared with liquid hydrogen.

In order to power the electric pump 10′ electrically, the feed device also includes an electricity generator 13′ installed on the shaft of the turbopump 8′ between the pump 8a′ and the turbine 8b′. The electric pump 10′, the inlet valves 7′ and 12′, the bypass valve 16′, and the outlet valve 24′ are connected to a control unit (not shown) for controlling the rocket engine 1′.

In order to start the rocket engine 1′, the turbopump 8′ must initially be cooled by opening the valve 12′. During this cooling, the bypass valve 16′ also remains open, while the outlet valve 24′ remains closed. Once the turbopump 8′ has been cooled, the valves 7′ and 22′ are opened, and the electric pump 10′ is started, being powered electrically by an external electricity source or by batteries (not shown), for example. The propellants then begin to flow towards the propulsion chamber 5′. Since the electric pump 10′ is already immersed in the liquid oxygen of the tank 2′, there is no need for a step of cooling the pump 10′. At least until a pressure threshold is reached, the background heat around the heat exchanger 9′ may be sufficient to vaporize the liquid hydrogen flowing through it, which should facilitate its ignition upon arrival into the propulsion chamber 5′.

The bypass valve 16′ remains open so that the flow of liquid or gaseous hydrogen can bypass the turbine 8b′. When a sufficient flow of both propellants is supplied to the propulsion chamber 5′, the mixture of propellants in the propulsion chamber 5′ is ignited by at least one ignitor (not shown). After ignition, the heat produced by the combustion of the mixture in the propulsion chamber 5′ contributes to heating and vaporizing the liquid hydrogen flowing through the heat exchanger 9′. The bypass valve 16′ can then be closed progressively so as to redirect the flow of gaseous hydrogen downstream from the heat exchanger 9′ towards the turbine 8b′ in such a manner as to cause the speed of the turbopump 8′ to increase. With increasing speed of the turbopump 8′, the generator 13′ can begin to generate electrical power for powering the electric pump 10′. Thereafter, the consumption of propellants by the rocket engine 1′ progressively empties the tanks 2′ and 3′. The speed of the electric pump 10′ can then be controlled throughout the operation of the rocket engine 1′ in order to avoid cavitation phenomena, in particular towards the end of the tank 2′ being emptied completely.

Although in this fourth embodiment the circuit 6′ operates with an “expander” cycle, in alternative embodiments the turbopump may be actuated in some other manner, e.g. by a gas generator such as that of the third embodiment.

Moreover, although the functioning of this rocket engine 1′ has been described for a propellant feeding process wherein the pressure of the hydrogen remains below the critical point, each propellant may be pumped at pressures above its respective critical point. As in the first embodiment, if the hydrogen is pumped at a pressure above its critical point, it will not be vaporized in the heat exchanger 9′, but instead flow as a supercritical fluid through the turbine 8b′ and into the propulsion chamber 5′.

In addition, although in these third and fourth embodiments the main source of electrical power for the electric pumps is an electricity generator actuated by the turbopump, it is also possible to envisage using other sources of electricity, for example a fuel cell such as that of the second embodiment. In general, for a rocket engine using liquid hydrogen and liquid oxygen and delivering thrust of less than 100 kilonewtons (kN), an electricity source delivering power of about 100 kilowatts (kW) can suffice. Apart from liquid hydrogen and liquid oxygen, it is also possible to envisage using other liquid propellants in other embodiments.

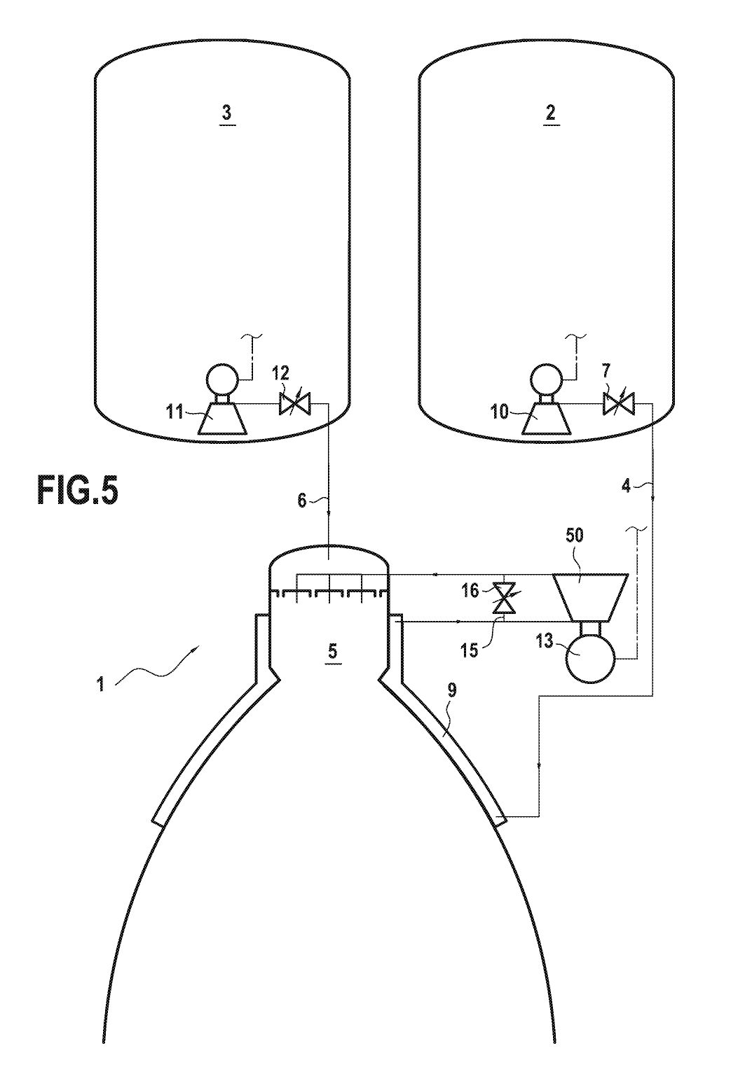

Although all previous embodiments comprise turbopumps, turbines not mechanically coupled to a pump may also be used. A rocket engine 1 with a feed device according to a fifth embodiment is shown in FIG. 5. Most of the elements of this rocket engine 1 are identical or equivalent to those of FIG. 1 and consequently they are given the same reference numbers. The feed device in this fifth embodiment nevertheless differs from that of the first embodiment in that, instead of mechanically coupling the turbine to a pump, forming a turbopump, the turbine 50 is only mechanically coupled to the generator 13. In this embodiment, the generator 13 and the electric pump 10 are dimensioned so that this electric pump 10, driven by the power supplied by the generator 13, can fulfill the pressure and flow rate requirements of the first feed circuit 4 without an additional pump.

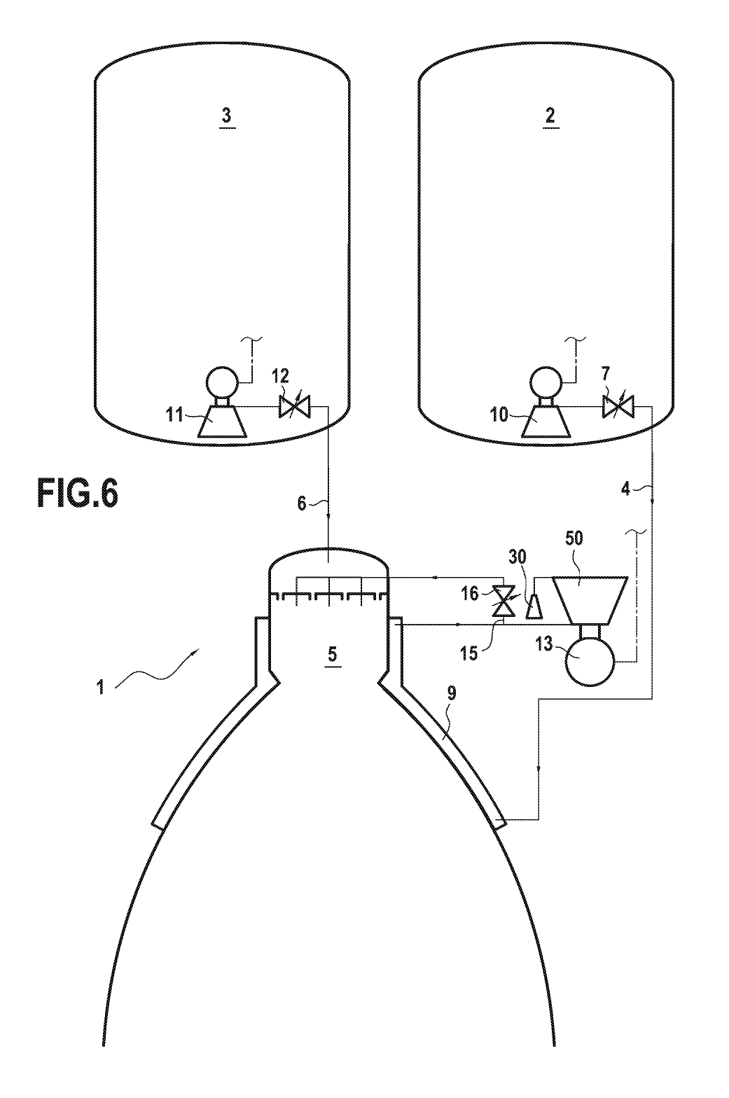

Although in this fifth embodiment, as in the first embodiment, the flow of the first propellant through the turbine 50 is injected in the propulsion chamber 5, in an alternative sixth embodiment, shown on FIG. 6, that flow is instead exhausted through an exhaust nozzle 30, as in the third embodiment. The remaining elements of the rocket engine 1 of FIG. 6 are identical or equivalent to those of FIG. 5 and consequently they are given the same reference numbers.

Although the present invention is described above with reference to specific embodiments, it is clear that various modifications and changes may be applied thereto without going beyond the general scope of the invention as defined by the claims. In addition, the individual characteristics of the various embodiments mentioned may be combined in additional embodiments. Consequently, the description and the drawings should be considered as being illustrative rather than restrictive.

What is claimed is:

1. A feed device for feeding a rocket engine propulsion chamber with at least a first propellant, the device comprising at least:
i) a first tank for containing said first propellant;
ii) a first feed circuit connected to the first tank; and
iii) at least one first electric pump within said first tank for pumping said first propellant through the first feed circuit.

2. The feed device according to claim 1, wherein said first feed circuit includes a first inlet valve downstream from the first electric pump.

3. The feed device according to claim 2, wherein said inlet valve is incorporated within the first tank.

4. The feed device according to claim 1, further comprising a turbine.

5. The feed device according to claim 4, wherein said first feed circuit further comprises a heat exchanger configured to heat the first propellant with heat generated within the propulsion chamber, and the turbine is located downstream of the heat exchanger in the first feed circuit.

6. The feed device according to claim 4, further comprising an electricity generator coupled to the turbine and connected to at least the first electric pump in order to electrically power at least the first electric pump.

7. The feed device according to claim 4, further comprising, downstream from at least the first electric pump, at least one pump mechanically coupled to the turbine for pumping said first propellant through the first feed circuit.

8. The feed device according to claim 4, wherein an outlet of the turbine is connected to the propulsion chamber.

9. The feed device according to claim 4, wherein an outlet of the turbine is connected to an exhaust nozzle.

10. The feed device according to claim 4, further including a gas generator connected to the turbine in order to actuate the turbine by expansion of gas generated by the gas generator.

11. The feed device according to claim 1, further including at least one fuel cell connected to at least the first electric pump in order to power it electrically.

12. The feed device according to claim 1, further including at least:
i) a second tank for containing a second propellant;
ii) a second feed circuit connected to the second tank; and
iii) a second electric pump within said second tank for pumping said second propellant through the second feed circuit.

13. A method of feeding a rocket engine propulsion chamber with at least a first propellant, wherein said first propellant is pumped through a first feed circuit from a first tank by at least a first electric pump that is immersed in the first propellant within the first tank.
